(19) United States
(12) Patent Application Publication
(10) Pub. No.: US 2026/0036149 A1
(43) Pub. Date: Feb. 5, 2026

(54) FLOW DUCTS, FLOW ASSEMBLIES, AND METHODS COMPRISING FLOW DUCTS

(71) Applicant: BULK ACCELERATOR, Portland, OR (US)

(72) Inventor: Adam CLAYTON, Portland, OR (US)

(21) Appl. No.: 18/793,548

(22) Filed: Aug. 2, 2024

(51) Int. Cl. F15D 1/04

(52) U.S. Cl. CPC F15D 1/04

(57) ABSTRACT

Flow ducts, flow assemblies, and methods comprising flow ducts are disclosed herein. A flow duct has a longitudinal axis and comprises an outer wall, an inner wall, vanes, and flow chambers. Vanes, outer and inner wall, collectively define flow chambers. An inlet side of outer surface intersects longitudinal axis and expands radially outward from longitudinal axis as outer surface extends in flow direction. An outlet side of outer surface contracts radially inward to intersect with longitudinal axis as outer surface extends in flow direction. Vanes extend radially outward, from outer surface to outer wall, and extend along and spiral around longitudinal axis. A flow assembly comprises a first section, a flow duct, and a second section comprising a bend or an intersection, wherein the second section is arranged downstream of flow duct. A method comprises imparting a rotation on a fluid by flowing the fluid through a flow duct.

### FIELD

The present disclosure relates to flow ducts, flow assemblies, and methods comprising flow ducts.

### BACKGROUND

Fluid flowing through a system or apparatus loses pressure due to a variety of factors. Reducing pressure loss in a system or apparatus reduces pumping requirements and wear on the system or apparatus. Flow features, such as flow ducts, can influence flow within a system or apparatus and reduce pressure losses.

### SUMMARY

Flow ducts, flow assemblies, and methods comprising flow ducts are disclosed herein. Examples of a flow duct have a longitudinal axis and comprise at least: an outer wall, an inner wall, vanes, and flow chambers. The outer wall extends along the longitudinal axis, defining both an inlet and an outlet. Fluids traverse through the flow duct from the inlet to the outlet, referred to as the flow direction.

Examples of an inner wall comprise an outer surface. An inlet side of outer surface intersects the longitudinal axis and expands radially outward from the longitudinal axis as the outer surface extends in the flow direction. An outlet side of the outer surface contracts radially inward to intersect with the longitudinal axis as the outer surface extends in the flow direction.

Examples of vanes extend radially outward from the outer surface to the outer wall, and extend along and spiral around the longitudinal axis. The vanes, outer wall, and inner wall collectively define flow chambers. The flow chambers extend along and spiral about the longitudinal axis.

In a further example, a flow assembly comprises a flow duct. An exemplary flow assembly comprises a first section, a flow duct, and a second section comprising a bend or an intersection, wherein the second section is arranged downstream of the flow duct.

In a further example, a method comprises imparting a rotation on a fluid by flowing the fluid through a flow duct.

### BRIEF DESCRIPTION OF THE DRAWINGS

FIG. 1 is a cross-sectional view of a flow duct.

FIG. 2 is a cross-sectional view of a flow duct.

FIG. 3 is a perspective view of a flow duct with part of outer wall cut away.

FIG. 4 is a perspective view of a flow duct with part of outer wall cut away.

FIG. 5 is a model of flow through a flow assembly.

FIG. 6 is a model of flow through a flow assembly comprising a flow duct and a bend.

FIG. 7 is a model of flow through a flow assembly.

FIG. 8 is a model of flow through a flow assembly comprising a flow duct and intersections.

FIG. 9 is a flow chart of methods for flow ducts and flow duct assemblies according to the present disclosure.

### DESCRIPTION

Apparatuses and methods for flow ducts are disclosed. Generally in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

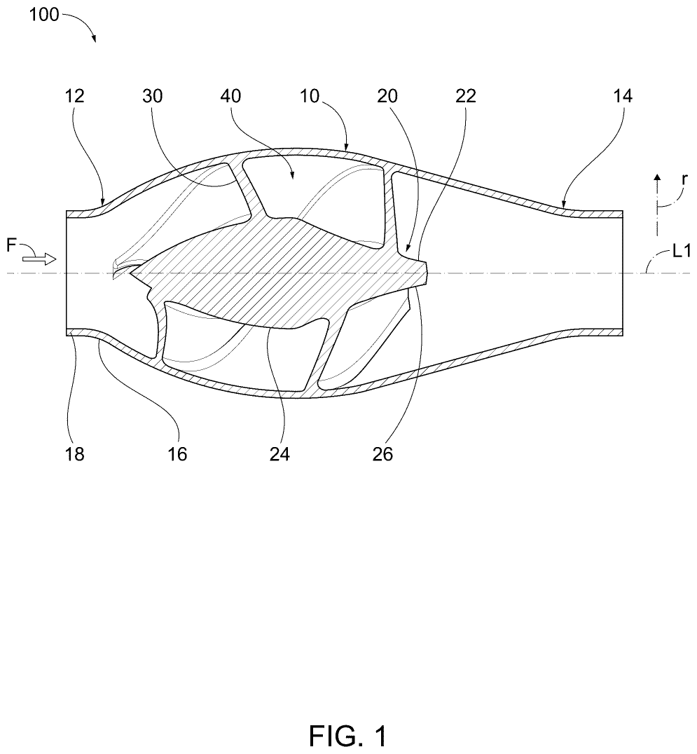

FIGS. 1-8 are illustrative, non-exclusive examples of flow ducts 100 and flow assemblies 300, and do not limit flow ducts 100 and flow assemblies 300 to the illustrated embodiments. That is, flow ducts 100 and flow assemblies 300 are not limited to the specific embodiments of FIGS. 1-8, and flow ducts 100 and flow assemblies 300 may incorporate any number of the various aspects, configurations, characteristics, properties, etc., of other examples without requiring the inclusion of all such aspects, configurations, characteristics, properties, etc. For the purpose of brevity, each previously discussed component, part, portion, aspect, region, etc., or variants thereof, may not be discussed, illustrated, and/or labeled again with respect to the examples of FIGS. 1-8; however, it is within the scope of the present disclosure that the previously discussed features, variants, etc., may be utilized with the examples of FIGS. 1-8.

As illustrated in FIG. 1, an exemplary flow duct 100 has a longitudinal axis (L1) and comprises at least: an outer wall 10, an inner wall 20, vanes 30, and flow chambers 40. Outer wall 10 extends along longitudinal axis (L1) and defines an inlet 12 and an outlet 14. Fluid flows in a direction (F) through flow duct 100 from inlet 12 to outlet 14.

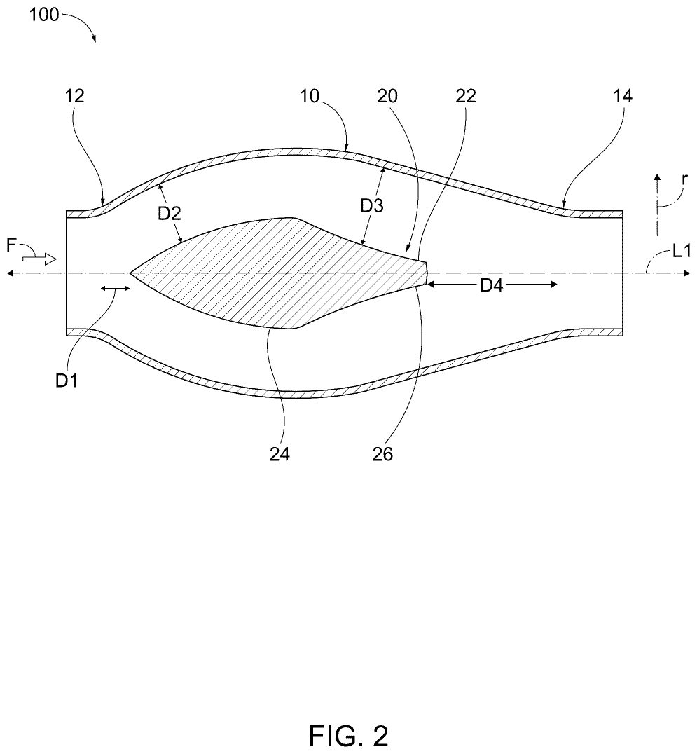

Inner wall 20 comprises an outer surface 22. An inlet side 24 of outer surface 22 intersects longitudinal axis (L1) and expands radially outward from longitudinal axis (L1) as outer surface 22 extends in flow direction (F). An outlet side 26 of outer surface 22 contracts radially inward to intersect with longitudinal axis (L1) as outer surface 22 extends in flow direction (F). Examples of inner wall 20 and outer surface 22 are depicted in FIG. 1 and FIG. 2. FIG. 2 does not depict vanes 30 to improve clarity in regard to inner wall 20 and outer wall 10.

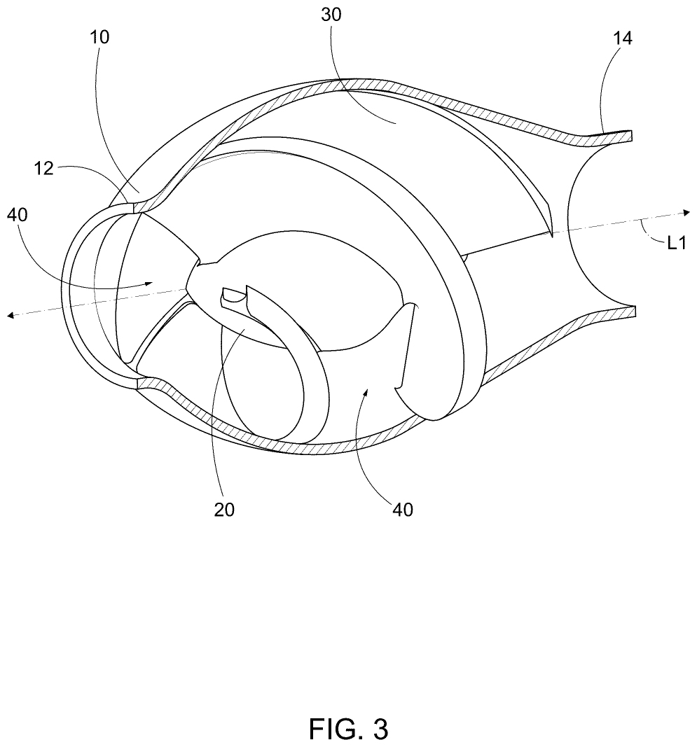

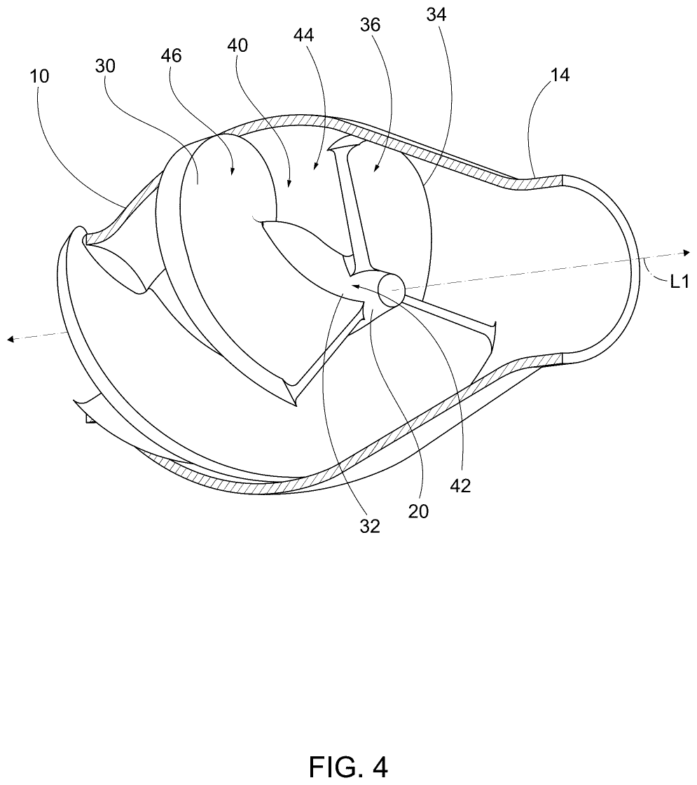

Vanes 30 extend radially outward from outer surface 22 to outer wall 10, and extend along and spiral around longitudinal axis (L1). Vanes 30, outer wall 10, and inner wall 20 collectively define flow chambers 40. Flow chambers extend along and spiral about longitudinal axis (L1). FIGS. 1, 3, and 4 depict vanes 30 and flow chambers 40. FIGS. 3 and 4 are perspective views with a portion of outer wall 10 cutaway, so that the shape and orientation of vanes 30 and flow chambers 40 can be seen.

Examples of outer wall 10, inner wall 20, and vanes 30 collectively define pathways for a fluid to flow through flow duct 100. Fluid flow enters through inlet 12, then travels through flow chambers 40 formed by vanes 30, outer wall 10, and inner wall 20, and then exits through outlet 14. Flow direction (F) is depicted in FIGS. 1 and 2, near inlet 12. Fluid travels radially outward around outer surface 22 of inner wall 20 as it flows in flow direction (F). The radial direction (r) is illustrated in FIGS. 1 and 2. FIG. 3 depicts a perspective view from a side of inlet 12, wherein pathways into flow chambers 40 can be seen. The fluid flow spirals around longitudinal axis (L1) as the fluid flow progresses through flow chambers 40, before exiting through outlet 14. FIG. 4 depicts a further view in which pathways from flow chambers 40 to outlet 14 are illustrated.

Examples of outer wall 10 define an outer radial boundary of fluid flow through flow duct 100. Outer wall 10 extends along and forms a circumference around longitudinal axis (L1). In other words, outer wall 10 holds fluid within flow duct 100. Examples of outer wall 10 also form outer circumferential surface 44 of flow chambers 40. The extension of outer wall 10 and longitudinal axis (L1) can be seen in FIGS. 1 and 2. The circumference of outer wall 10 around longitudinal axis (L1) can be seen in FIGS. 3 and 4.

In flow direction (F), examples of outer wall 10 increase in diameter and then decrease in diameter as outer wall 10 extends along longitudinal axis (L1). Examples of inner wall 20 similarly increase in diameter and then decrease in diameter as inner wall 20 extends in flow direction (F). The increase in diameter of outer wall 10 creates space for the fluid to flow radially outward, and the decrease in diameter of outer wall 10 forces the fluid back toward longitudinal axis (L1) and outlet 14. The cross-section of outer wall 10 in FIGS. 1 and 2 depicts an increase in diameter and a decrease in diameter in flow direction (F).

Examples of outer wall 10 vary in shape. Some examples of outer wall 10 form a smooth curve. An inner surface of outer wall 10 has a concave curvature. A curvature of outer wall 10 may vary relative to longitudinal axis (L1). One example of outer wall 10 has an opening angle 16 relative to longitudinal axis (L1). The opening angle 16 is an angle of a portion of outer wall 10, located where outer wall 10 begins increasing in diameter. In other words, the opening angle 16 allows fluid flow to begin expanding outward. Examples of the opening angle 16 are between 5-35 degrees. In other examples, the opening angle 16 may be 10, 15, 20, 25, or 30 degrees. The opening angle 16 may affect fluid flow. For example, a large opening angle 16 may cause cavitation in some applications, whereas a low small opening angle 16 may have less of an effect on a boundary layer between a bulk fluid and outer wall 10. Opening angle 16 is depicted in FIG. 1.

Examples of inner wall 20 define an interior radial boundary for fluid flow in a portion of a flow duct 100. Examples of inner wall 20 define an inner circumferential surface 42 of flow chambers 40, as depicted in FIG. 4. Inner wall 20 intersects longitudinal axis (L1) and expands radially outward from longitudinal axis (L1). Thus, when fluid flow contacts the inlet side 24 of inner wall 20, the fluid must flow radially outward and around outer surface 22 of inner wall 20. In other words, the fluid flow in the direction of longitudinal axis is broken-up, as it must flow radially outward and around outer surface 22 of inner wall 20.

The shape of inner wall 20 influences of inner wall 20 on the fluid flow. Examples of the inlet side 24 of inner wall 20 increase in diameter as outer surface 22 extends in flow direction (F), and examples of the outlet side 26 of inner wall 20 decrease in diameter as outer surface 22 extends in flow direction (F). Examples of outer surface 22 are continuous and therefore, the fluid flow in flow direction (F), is forced radially outward and around the inlet side 24, then flows radially inward along the outlet side 26, and then converges beyond outer surface 22. The cross-sections of FIGS. 1 and 2 depict the diameter of inner wall 20 increasing and then decreasing in diameter.

The shape of inner wall 20 may also be described in terms of curvature. Examples of the inlet side 24 have a convex curvature, and examples of the outlet side 26 have a concave curvature. The curvature of inner wall 20 can be seen in each of FIGS. 1-4. The cross-sectional views of FIGS. 1-2 particularly depicts the concave curvatures and the convex curvatures. Examples of the curvature of the inlet side 24 have an angle relative to longitudinal axis (L1) of between 5-30 degrees, and examples of curvature of the outlet side 26 have an angle relative to longitudinal axis (L1) of between 5-35 degrees. In other examples, the curvature of the inlet side 24 has an angle relative to longitudinal axis (L1) of 10, 15, 20, or 25 degrees. In further examples, the curvature of the outlet side 26 has an angle relative to longitudinal axis (L1) of 10, 15, 20, 25, or 30 degrees Similarly to the opening angle 16 of outer wall 10, the angle of the curvature of the inlet side 24 and the outlet side 26 influences the fluid flow. For example, a large angle on the outlet side 26 of inner wall may cause flow separation in some applications.

Similarly, the shape of inner wall 20 influences pressure loss of fluid flowing through flow duct 100. Thus, in some examples, inlet side 24 has a conical shape and the outlet side 26 has a conical shape. The conical shape of both the inlet side 24 and outlet side 26 may also be described as inner wall 20 having a tear drop, bullet, or bulb-shaped. The examples of FIGS. 1 and 2 depict an inlet side 24 with a conical shape and a convex curvature of outer surface 22. Similarly, the examples of FIGS. 1 and 2 depict an outlet side 26 with a conical shape and a concave curvature of outer surface 22. The examples of FIGS. 1 and 2 further depict inner wall 20 centered and aligned with longitudinal axis (L1) and the outlet side 26 terminating before coming to a point.

Inner wall 20 extends along longitudinal axis (L1) within outer wall 10. Vanes 30 connect inner wall 20 with outer wall 10. In some examples, inner wall 20 is suspended within flow duct 100 by vanes 30. In further examples, inner wall 20 does not contact outer wall 10. The distance between inner wall 20 and outer wall 10 provides space for fluid to flow. In other words, an inner circumferential surface 42 of flow chambers 40 is defined by the inner wall 20, and an outer circumferential surface 44 of flow chambers 40 is defined by outer wall 10. FIG. 4 depicts flow chambers 40 including inner circumferential surface 42 and outer circumferential surface 44.

A distance between inner wall 20 and outer wall 10 varies among examples. In examples where the inlet side 24 of inner wall 20 has convex curvature and the outlet side 26 has concave curvature, a distance between inner wall 20 and outer wall 10 will vary with the curvature of inner wall 20. Furthermore, inner wall 20 may be offset relative to outer wall 10. For example, FIG. 2 depicts an outlet-side radial distance (D3) between inner wall 20 and outer wall 10 that is greater than an inlet-side distance (D2) between inner wall 20 and outer wall 10. In further examples, such as FIGS. 1 and 2, a convex curvature of the inlet side 24 may have an approximately constant distance between inner wall 20 and outer wall 10, whereas the distance between inner wall 20 and outer wall 10 may increase in flow direction (F) on outlet side 26. The example of FIG. 2 further depicts an outlet-side distance (D4) between the outlet side 26 and outlet 14 is greater than an inlet-side distance (D1) between inlet side 24 and inlet 12. In still further examples, inlet 12 comprises a straight portion 18, which has a constant diameter, and wherein a radial distance between inner wall 20 and the inner surface of outer wall 10 is 1.1-1.5 times a radius of the straight portion 18.

Further examples of inner wall 20 comprise an outer surface 22, which does not have any entrances or passages that allow fluid to flow radially inward of outer surface 22. In other words, outer surface 22 is continuous and uninterrupted, such that fluid flow cannot move through outer surface 22. In still further words, outer surface 22 does not have features that allow for the fluid to flow into the area radially interior of outer surface 22. The perspective view of FIGS. 3 and 4 depict the continuous and uninterrupted surface of outer surface 22.

Vanes 30 also define flow paths through flow duct 100. An example of a vane 30 defines radial surfaces 46 of flow chambers 40. Therefore, flow chambers 40 are formed by an inner circumferential surface 42 defined by inner wall 20, an outer circumferential surface 44 defined by outer wall 10, and two radial surfaces 46 defined by vanes 30. Vanes 30 also separate the fluid flow into separate flow chambers 40.

Vanes 30 spiral around longitudinal axis (L1). Examples of vanes 30 extend in a helical shape around longitudinal axis (L1). The spiraling of vanes 30 imparts rotational acceleration on the fluid traveling through flow chambers 40. In some examples, a rotational velocity of the fluid is maintained after the fluid exits outlet 14.

The shape of vanes 30 spiraling around longitudinal axis (L1) varies. In some examples, a distance between loops of the helical shape of vanes 30 is not constant. In other examples, a distance between loops of the helical shape of vanes 30 may be constant, increase in flow direction (F), or decrease in flow direction (F). In further examples of vanes 30, an inner diameter 32 of vanes 30 is defined by outer surface 22 of inner wall 20, and an outer diameter 34 of vanes 30 is defined by outer wall 10. In these examples, the inner diameter 32 and the outer diameter 34 may change based on the curvatures of inner wall 20 and outer wall 10.

Vanes 30, inner wall 20, and outer wall 10 collectively form flow chambers 40. In some examples, each vane 30 comprise two contact surfaces 36. The contact surfaces 36 extend in a radial direction and a longitudinal direction. In further examples, one of the two contact surfaces 36 has a concave curvature, and the other of the two contact surfaces 36 has a convex curvature. In still further examples, the curvature of the contact surfaces 36 may correspond to a twist of helical vanes 30. For example, vanes 30 may have a right-hand twist around longitudinal axis (L1), and the curvatures of vanes 30 may be such that an outer portion of the vanes 30 extend in a direction of the right-hand twist. FIG. 3 depicts an example in which the curvature of vanes 30 extends in the same direction of the spiral of vanes 30, in this case, a right-hand twist. In other examples, vanes 30 may have a left-hand twist, and the curvatures of vanes 30 may correspond to the left-hand twist. In other examples, vanes 30 may not have significant curvature, or the curvature of vanes 30 may not correspond to the direction of spiral of vanes 30.

Vanes 30 spiral about longitudinal axis (L1). In other words, vanes 30 extend in a direction of longitudinal axis (L1), while simultaneously extending in an arc around longitudinal axis (L1). The shape of vanes 30 may also be referred to as helical or screw-shaped. Examples of helical-shaped vanes 30 are depicted in FIGS. 3 and 4, in which the perspective view illustrates the shape of vanes 30. In some examples, each vane 30 spirals 100-720 degrees around longitudinal axis (L1). In other examples, each vane 30 spirals 135, 180, 225, 270, 315, 360, 405, 450, 495, 540, 585, 630, or 675 degrees around longitudinal axis (L1). The spiral of vanes 30 is partially defined by a pitch of vanes 30 relative to longitudinal axis (L1). In other words, a vane 30 with a high pitch angle will extend in a direction more traverse to longitudinal axis (L1) than a vane 30 with a low pitch angle. For example, a vane 30 with a high pitch may spiral around longitudinal axis 720 degrees, while a vane with a low pitch may spiral around longitudinal axis 100 degrees. In an example, vanes 30 have a first pitch on the inlet side 24 of flow duct 100 and the first pitch increase in a direction of the flow, wherein the first pitch is relative to longitudinal axis (L1), and wherein the first pitch varies from 5-45 degrees relative to longitudinal axis (L1). In other examples, the first pitch of a vane may be 10, 15, 20, 25, 30, 35, or 40 degrees relative to longitudinal axis (L1).

Vanes 30, inner wall 20, and outer wall 10 extend along longitudinal axis (L1). In some examples, vanes 30 extend beyond inner wall 20 in a direction opposite flow direction (F), and inner wall 20 extends beyond vanes 30 in flow direction (F). In other words, fluid flow in the flow direction will contract vanes 30 prior to inner wall 20, and then fluid flow will flow past an outlet-side terminal edge of vanes 30, prior to flowing past an outlet-side terminal surface of inner wall 20. FIG. 1 depicts an example in which vanes 30 extend closer to inlet 12 than inner wall 20, and inner wall 20 extends closer to outlet 14 than vanes 30. In other examples, inner wall 20 may extend beyond vanes 30 in a direction opposite flow direction (F), or inner wall 20 and vanes 30 may extend to the same point. Similarly in some examples, vanes 30 extend beyond inner wall 20 in flow direction (F) or, in other examples, inner wall 20 and vanes 30 extend to the same point.

Outer wall 10, inner wall 20, and vanes 30 collectively form flow chambers 40. Examples of flow chambers 40 are formed by an inner circumferential surface 42 defined by inner wall 20, an outer circumferential surface 44 defined by outer wall 10, and two radial surfaces 46 defined by vanes 30. In some examples three or more flow chambers 40 are formed. Flow chambers 40 are formed by outer wall 10, inner wall 20, and vanes 30 and thus, the shape of outer wall 10, inner wall 20, and vanes 30 define the shape of flow chambers 40. For example, the spiral of vanes 30 defines the spiral of flow chambers 40 around longitudinal axis (L1). Similarly, the curvature of outer wall 10 and inner wall 20 define the shape of outer circumferential surface 44 and inner circumferential surface 42.

Fluid flows through flow duct 100 in flow direction (F) from inlet 12, through flow chambers 40, and then exits outlet 14. In some examples, fluid flows sequentially into an initial spin region comprising only vanes 30; an expansion region where inner wall 20 and outer wall 10 increase in diameter; a recombination region where vanes 30 terminate and the flow exits flow chambers 40; and a convergence region where inner wall 20 terminates.

Fluid flow enters flow chambers 40 from inlet 12 of flow duct 100. Examples of inner wall 20 are centered on longitudinal axis (L1), and the fluid flow is symmetrical around outer surface 22 of inner wall 20. Thus, fluid flow is diverted radially outward by inner wall 20 and then separated into flow chambers 40 by vanes 30.

The shape of outer wall 10, inner wall 20, and vanes 30 and therefore, flow chambers 40, influence fluid flow though flow duct 100. Flow chambers 40 spiral around longitudinal axis (L1) and thus, in some examples, flow chambers 40 impart a rotational acceleration on the fluid flow through flow chambers 40. In further examples, a rotational velocity of the fluid continues downstream of flow duct 100.

Rotational velocity in fluid can interfere with formation of a laminar flow boundary layer and create a turbulent boundary layer. Turbulent boundary layers can reduce flow separation as fluid travels through features such as bends and intersections. Reduction of flow separation may reduce a pressure drop of fluid flow through features and therefore reduce pumping force requirements.

Examples of flow duct 100 are part of a flow assembly 300. An exemplary flow assembly 300 comprises a first section (S1), a flow duct 100, and a second section (S2) comprising a bend 102 or an intersection 104, wherein the second section (S2) is arranged downstream of flow duct 100. Additional examples of second section (S2) comprise diffusers, nozzles, expansions, contractions, elbows, joints, concentric reducers, eccentric reducers, valves, filters, and/or baffles. Examples of expansions and contractions are diffusers and nozzles. Diffusers and nozzles are used to manage flow velocity and pressure. Examples of elbows comprise 45-degree and 90-degree elbows. Elbows are used for changing the direction of flow. Examples of joints include T-joints and Y-joints. Joints are used for splitting and combining flow. Concentric and eccentric reducers are used to facilitate smooth transitions between different pipe diameters. Examples of valves comprise: ball, gate, butterfly, and check valves. Valves are used to regulate flow rate and direction. Filters, for example mesh filters, are used to remove particulates. Internal baffles are used to direct flow and ensure efficient distribution and mixing.

Examples of flow duct 100 impart rotational velocity onto the fluid which then flows through bend 102 and/or intersection 104 of second section (S2). Rotational velocity of fluid traveling through bend 102 and/or intersection 104 of second section (S2) may reduce an amount of flow pressure loss through bend 102 and/or intersection 104 of second section (S2), and therefore reduce pumping force requirements.

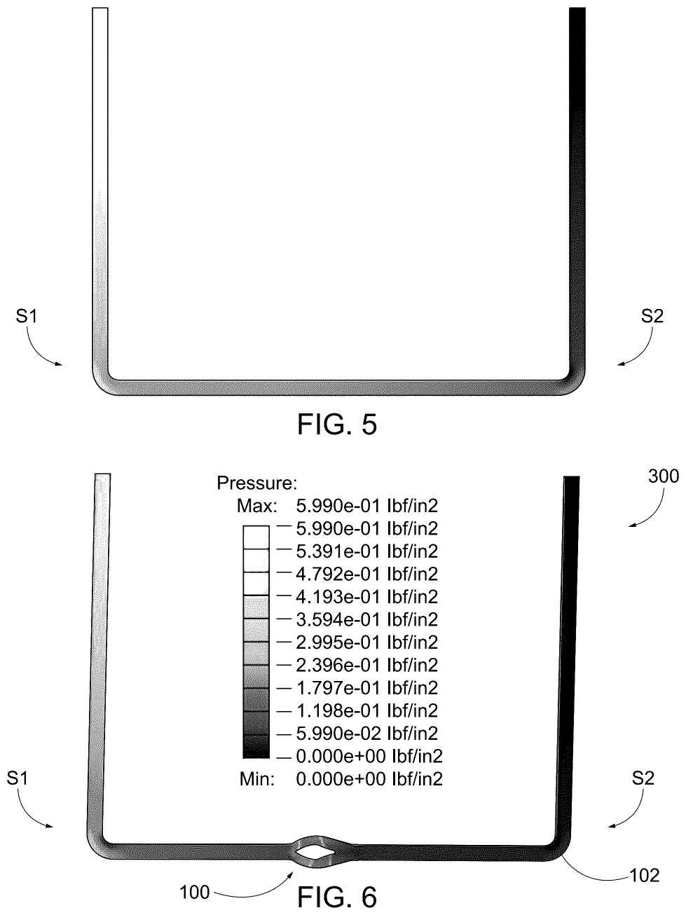

FIG. 5 depicts a model of pressure of flow through a flow assembly comprising a bend 102. FIG. 6 depicts a model of pressure of flow through a flow assembly 300 comprising flow duct 100 and bend 102. A comparison on FIGS. 5 and 6 depicts that the pressure loss of flow through bend 102 is reduced by flow duct 100 positioned upstream of bend 102.

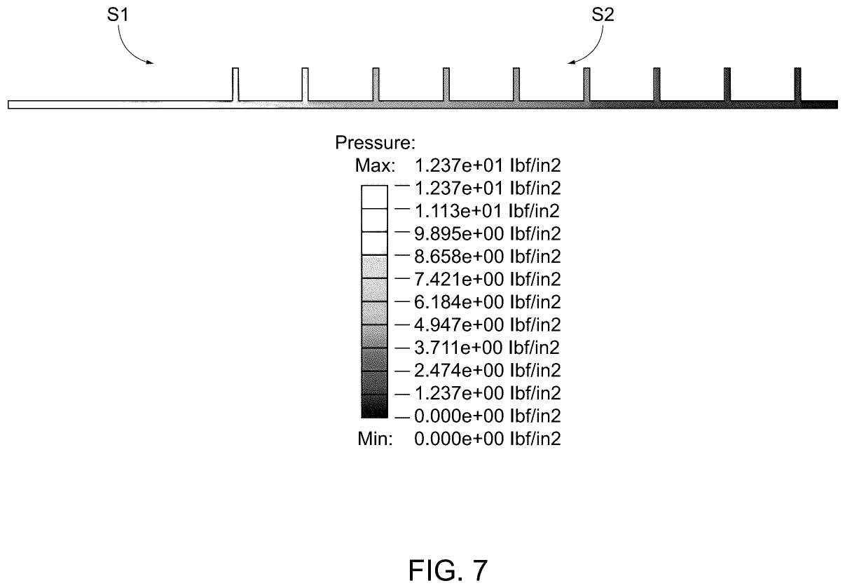

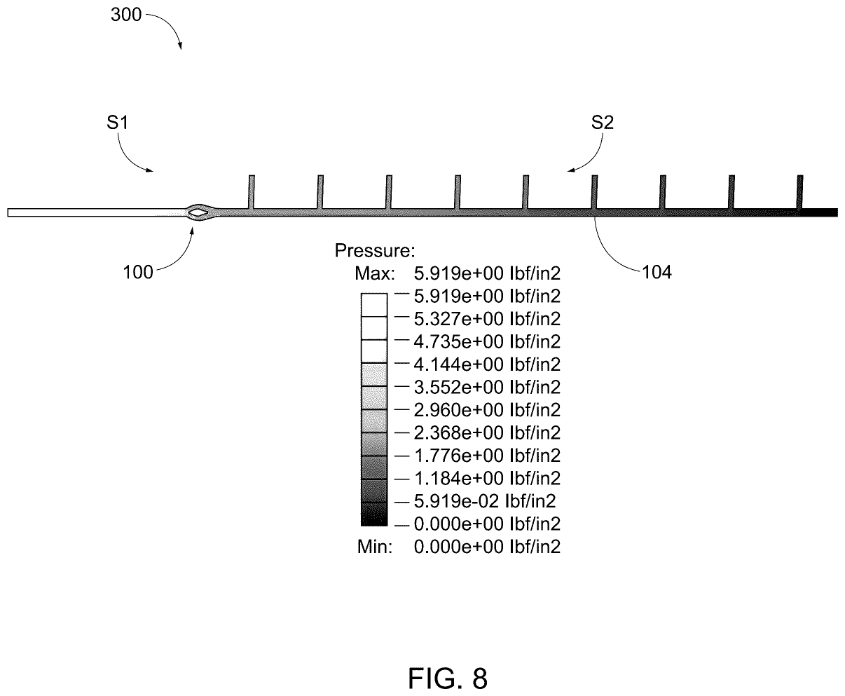

Similarly, FIG. 7 depicts a model of pressure of flow through a flow assembly comprising intersections 104. FIG. 8 depicts a model of pressure of flow through a flow assembly 300 comprising flow duct 100 and intersections 104. A comparison on FIGS. 7 and 8 depicts that the pressure loss of flow through intersections 104 is reduced by flow duct 100 positioned upstream of bend intersections 104.

Further examples of flow duct 100 induce turbulence within the fluid and reduce a pressure loss of the fluid flowing through the second section (S2). In further examples, the fluid continues rotating in the second section (S2). Rotation of the fluid may induce turbulence and reduce pressure loss as the fluid flows through flow features.

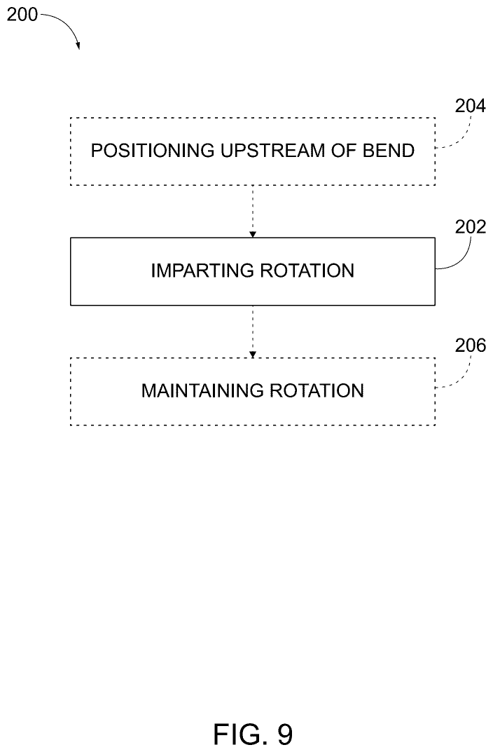

FIG. 9 schematically provides a flowchart that represents illustrative, non-exclusive examples of methods according to the present disclosure. In FIG. 9, some steps are illustrated in dashed boxes, indicating that such steps may be optional or may correspond to an optional version of a method according to the present disclosure. That said, not all methods according to the present disclosure are required to include the steps illustrated in solid boxes. The methods and steps illustrated in FIG. 9 are not limiting and other methods and steps are within the scope of the present disclosure, including methods having greater than or fewer than the number of steps illustrated, as understood from the discussions herein.

Methods including flow duct 100 are further disclosed. One example of method 200 comprises imparting rotation 202 on a fluid by flowing the fluid through flow duct 100. Further examples of method 200 include positioning 204 flow duct 100 upstream of bend 102 or intersection 104. FIGS. 6 and 8 depict a flow duct 100 upstream of bend 102 and intersection 104, respectively.

Further examples of method 200 include maintaining rotation 206 of the fluid as the fluid flows through the bend 102 or the intersection 104. Still further examples of flow duct 100 reduce a pressure loss of the fluid flowing through bend 102 or intersection 104.

Illustrative, non-exclusive examples of inventive subject matter according to the present disclosure are described in the following enumerated paragraphs:

A. A flow duct (100) having a longitudinal axis (L1), the flow duct (100) comprising:
an outer wall (10) extending along the longitudinal axis (L1) and defining an inlet (12) and an outlet (14), wherein a flow direction (F) is from the inlet (12) to the outlet (14);
an inner wall (20) comprising an outer surface (22), an inlet side (24) of the outer surface (22), which intersects the longitudinal axis (L1) and expands radially outward from the longitudinal axis (L1) as the outer surface (22) extends in the flow direction (F), and an outlet side (26) of the outer surface (22), which contracts radially inward to intersect with the longitudinal axis (L1) as the outer surface (22) extends in the flow direction (F);
vanes (30) extending radially outward from the outer surface (22) to the outer wall (10) and extending along and spiraling around the longitudinal axis (L1);
wherein the outer wall (10), the inner wall (20), and the vanes (30) collectively define flow chambers (40) that extend along and spiral about the longitudinal axis (L1).

A1. The flow duct (100) of paragraph A, wherein, in the flow direction (F), the outer wall (10) increases in diameter and then decreases in diameter as the outer wall (10) extends along the longitudinal axis (L1).

A2. The flow duct (100) of paragraph A1, wherein the outer wall (10) has an opening angle (16) relative to the longitudinal axis (L1), wherein the opening angle (16) is an angle of a portion of the outer wall (10) located where the outer wall (10) begins increasing in diameter, and wherein the opening angle (16) is between 5 and 35 degrees.

A3. The flow duct (100) any of paragraphs A1-A2, wherein the outer surface (22) is continuous such that flow, in the flow direction (F), is forced radially outward around the inlet side (24), then flows radially inward along the outlet side (26), and then converges beyond the outer surface (22).

A4. The flow duct (100) any of paragraphs A1-A3, wherein the inlet side (24) increases in diameter as the outer surface (22) extends in the flow direction (F), and the outlet side (26) decreases in diameter as the outer surface (22) extends in the flow direction (F).

A5. The flow duct (100) any of paragraphs A1-A4, wherein the inlet side (24) has convex curvature and the outlet side (26) has concave curvature.

A5.1. The flow duct (100) of paragraph A5, wherein curvature of the inlet side (24) has an angle relative to the longitudinal axis (L1) between 5-30 degrees.

A5.2. The flow duct (100) of paragraph A5, wherein curvature of the outlet side (26) has an angle relative to the longitudinal axis (L1) between 5-35 degrees.

A6. The flow duct (100) any of paragraphs A1-A5.2, wherein the inlet side (24) has a conical shape and the outlet side (26) has a conical shape.

A7. The flow duct (100) any of paragraphs A1-A6, wherein the inner wall (20) is suspended within the flow duct (100) by the vanes (30).

A7.1. The flow duct (100) any of paragraphs A1-A6, wherein the inner wall (20) does not contact the outer wall (10).

A8. The flow duct (100) any of paragraphs A1-A7.1, wherein the inlet (12) comprises a straight portion (18), which has a constant diameter, and wherein a radial distance between the inner wall (20) and the outer wall (10) is 1.1-1.5 times a radius of the straight portion (18).

A8.1. The flow duct (100) any of paragraphs A1-A7.1, wherein an outlet-side radial distance (D3) between the inner wall (20) and the outer wall (10) is greater than an inlet-side distance (D2) between the inner wall (20) and the outer wall (10).

A9. The flow duct (100) any of paragraphs A1-A8.1, wherein each vane (30) extends in a helical shape around the longitudinal axis (L1).

A10. The flow duct (100) of paragraph A9, wherein a distance between loops of the helical shape of the vanes (30) is not constant.

A11. The flow duct (100) any of paragraphs A1-A10, wherein an inner diameter (32) of the vanes (30) is defined by the outer surface (22), and an outer diameter (34) of the vanes (30) is defined by the outer wall (10).

A12. The flow duct (100) any of paragraphs A1-A11, wherein each vanes (30) comprise two contact surfaces (36), which extend in a radial direction and a longitudinal direction, wherein one of the two contact surfaces (36) has a concave curvature and the other of the two contact surfaces (36) has a convex curvature.

A13. The flow duct (100) any of paragraphs A-A12, wherein the vanes (30) extend beyond the inner wall (20) in a direction opposite the flow direction (F), and the inner wall (20) extends beyond the vanes (30) in the flow direction (F).

A14. The flow duct (100) any of paragraphs A-A13, wherein each vane (30) spirals 100-720 degrees around the longitudinal axis (L1).

A15. The flow duct (100) any of paragraphs A-A14, wherein the vanes (30) have a first pitch on the inlet side (24) of the flow duct (100) and the first pitch increase in a direction of the flow, wherein the first pitch is relative to the longitudinal axis (L1), and wherein the first pitch varies from 5-45 degrees relative to the longitudinal axis (L1).

A16. The flow duct (100) any of paragraphs A-A15, wherein the outer wall (10), the inner wall (20), and the vanes (30) collectively form three or more flow chambers (40).

A17. The flow duct (100) any of paragraphs A-A16, wherein an inner circumferential surface (42) of the flow chambers (40) is defined by the inner wall (20), an outer circumferential surface (44) of the flow chambers (40) is defined by the outer wall (10), and two radial surfaces (46) of the flow chambers (40) are defined by the vanes (30).

A18. The flow duct (100) any of paragraphs A-A17, wherein fluid flows sequentially into an initial spin region comprising only the vanes (30), an expansion region, wherein the inner wall (20) and the outer wall (10) increase in diameter, a recombination region, wherein the vanes (30) terminate and the fluid flow exits the flow chambers (40), and a convergence region, where the inner wall (20) terminates.

A19. The flow duct (100) any of paragraphs A-A18, wherein the flow chambers (40) impart a rotational acceleration on a/the flow through the flow chambers (40), and wherein a rotational velocity on the flow continues downstream of the flow duct (100).

A20. The flow duct (100) of paragraph A-A19, wherein the inner wall (20) is centered on the longitudinal axis (L1) and a/the flow is symmetrical around the outer surface (22) of the inner wall (20).

B. A flow assembly (300) comprising:
a first section (S1);
a flow duct (100) having a longitudinal axis (L1), the flow duct (100) comprising:
   an outer wall (10) extending along the longitudinal axis (L1) and defining an inlet (12) and an outlet (14), wherein a flow direction (F) is from the inlet (12) to the outlet (14);
   an inner wall (20) comprising an outer surface (22), an inlet side (24) of the outer surface (22), which intersects the longitudinal axis (L1) and expands radially outward from the longitudinal axis (L1) as the outer surface (22) extends in the flow direction (F), and an outlet side (26) of the outer surface (22), which contracts radially inward to intersect with the longitudinal axis (L1) as the outer surface (22) extends in the flow direction (F), wherein the outer surface (22) does not have any entrances or passages that allow a fluid to flow radially inward of the outer surface (22);
   vanes (30) extending radially outward from the outer surface (22) to the outer wall (10), and extending along and spiraling around the longitudinal axis (L1);
   wherein the outer wall (10), the inner wall (20), and the vanes (30) collectively define flow chambers (40) that extend along and spiral about the longitudinal axis (L1); and
a second section (S2) comprising a bend (102) or an intersection (104), wherein the second section (S2) is arranged downstream of the flow duct (100).

B1. The flow duct (100) of paragraph B, wherein the flow duct (100) induces turbulence within the fluid and reduces a pressure loss of the fluid flowing through the second section (S2).

B2. The flow duct (100) any of paragraphs B-B1, wherein the fluid continues rotating in the second section (S2).

C. A method (200) comprising:
imparting rotation (202) on a fluid by flowing the fluid through a flow duct (100), the flow duct (100) having a longitudinal axis (L1), and the flow duct (100) comprising:
   an outer wall (10) extending along the longitudinal axis (L1) and defining an inlet (12) and an outlet (14), wherein a flow direction (F) is from the inlet (12) to the outlet (14);
   an inner wall (20) comprising an outer surface (22), an inlet side (24) of the outer surface (22), which intersects the longitudinal axis (L1) and expands radially outward from the longitudinal axis (L1) as the outer surface (22) extends in the flow direction (F), and an outlet side (26) of the outer surface (22), which contracts radially inward to intersect with the longitudinal axis (L1) as the outer surface (22) extends in the flow direction (F), wherein the outer surface (22) does not have any entrances or passages that allow the fluid to flow radially inward of the outer surface (22);
   vanes (30) extending radially outward from the outer surface (22) to the outer wall (10), and extending along and spiraling around the longitudinal axis (L1); and
   wherein the outer wall (10), the inner wall (20), and the vanes (30) collectively define flow chambers (40) that extend along and spiral about the longitudinal axis (L1).

C1. The method of paragraph C, further comprising positioning (204) the flow duct (100) upstream of a bend (102) or an intersection (104).

C2. The method of paragraph C1, further comprising maintaining rotation (206) of the fluid as the fluid flows through the bend (102) or the intersection (104).

C3. The method of paragraph C1-C2, wherein the flow duct (100) reduces a pressure loss of the fluid flowing through the bend (102) or the intersection (104).

D. The use of a flow duct (100) having a longitudinal axis (L1), the flow duct (100) comprising:
an outer wall (10) extending along the longitudinal axis (L1) and defining an inlet (12) and an outlet (14), wherein a flow direction (F) is from the inlet (12) to the outlet (14);
an inner wall (20) comprising an outer surface (22), an inlet side (24) of the outer surface (22), which intersects the longitudinal axis (L1) and expands radially outward from the longitudinal axis (L1) as the outer surface (22) extends in the flow direction (F), and an outlet side (26) of the outer surface (22) which contracts radially inward to intersect with the longitudinal axis (L1) as the outer surface (22) extends in the flow direction (F);
vanes (30) extending radially outward from the outer surface (22) to the outer wall (10) and extending along and spiraling around the longitudinal axis (L1);
wherein the outer wall (10), the inner wall (20), and the vanes (30) collectively define flow chambers (40) that extend along and spiral about the longitudinal axis (L1).

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A flow duct having a longitudinal axis, the flow duct comprising:
an outer wall extending along the longitudinal axis and defining an inlet and an outlet, wherein a flow direction is from the inlet to the outlet;
an inner wall comprising an outer surface, an inlet side of the outer surface, which intersects the longitudinal axis and expands radially outward from the longitudinal axis as the outer surface extends in the flow direction, and an outlet side of the outer surface which contracts radially inward to intersect with the longitudinal axis as the outer surface extends in the flow direction; and
vanes extending radially outward from the outer surface to the outer wall and extending along and spiraling around the longitudinal axis;
wherein the outer wall, the inner wall, and the vanes collectively define flow chambers that extend along and spiral about the longitudinal axis.

2. The flow duct of claim 1, wherein, in the flow direction, the outer wall increases in diameter and then decreases in diameter as the outer wall extends along the longitudinal axis.

3. The flow duct of claim 1, wherein the outer surface is continuous such that flow, in the flow direction, is forced radially outward around the inlet side, then flows radially inward along the outlet side, and then converges beyond the outer surface.

4. The flow duct of claim 1, wherein the inlet side increases in diameter as the outer surface extends in the flow direction, and the outlet side decreases in diameter as the outer surface extends in the flow direction.

5. The flow duct of claim 1, wherein the inlet side has convex curvature and the outlet side has concave curvature.

6. The flow duct of claim 1, wherein the inlet side has a conical shape and the outlet side has a conical shape.

7. The flow duct of claim 1, wherein the inner wall is suspended within the flow duct by the vanes.

8. The flow duct of claim 1, wherein an outlet-side radial distance between the inner wall and the outer wall is greater than an inlet-side distance between the inner wall and the outer wall.

9. The flow duct of claim 1, wherein each vane extends in a helical shape around the longitudinal axis.

10. The flow duct of claim 1, wherein each vane comprises two contact surfaces, which extend in a radial direction and a longitudinal direction, wherein one of the two contact surfaces has a concave curvature and the other of the two contact surfaces has a convex curvature.

11. The flow duct of claim 1, wherein the vanes extend beyond the inner wall in a direction opposite the flow direction, and the inner wall extends beyond the vanes in the flow direction.

12. The flow duct of claim 1, wherein each vane spirals 100-720 degrees around the longitudinal axis.

13. The flow duct of claim 1, wherein the outer wall, the inner wall, and the vanes collectively form three or more flow chambers.

14. The flow duct of claim 1, wherein an inner circumferential surface of the flow chambers is defined by the inner wall, an outer circumferential surface of the flow chambers is defined by the outer wall, and two radial surfaces of the flow chambers are defined by the vanes.

15. A flow assembly comprising:
a first section;
a flow duct having a longitudinal axis, the flow duct comprising:
an outer wall extending along the longitudinal axis and defining an inlet and an outlet, wherein a flow direction is from the inlet to the outlet;
an inner wall comprising an outer surface, an inlet side of the outer surface, which intersects the longitudinal axis and expands radially outward from the longitudinal axis as the outer surface extends in the flow direction, and an outlet side of the outer surface, which contracts radially inward to intersect with the longitudinal axis as the outer surface extends in the flow direction, wherein the outer surface does not have any entrances or passages that allow fluid to flow radially inward of the outer surface; and
vanes extending radially outward from the outer surface to the outer wall and extending along and spiraling around the longitudinal axis;
wherein the outer wall, the inner wall, and the vanes collectively define flow chambers that extend along and spiral about the longitudinal axis; and
a second section comprising a bend or an intersection, wherein the second section is arranged downstream of the flow duct.

16. The flow assembly of claim 15, wherein fluid flows sequentially into an initial spin region comprising only the vanes, an expansion region, wherein the inner wall and the outer wall increase in diameter, a recombination region, wherein the vanes terminate and the flow exits the flow chambers, and a convergence region, wherein the inner wall terminates.

17. The flow assembly of claim 15, wherein the inner wall is centered on the longitudinal axis, and the fluid flows symmetrically around the outer surface of the inner wall.

18. A method comprising:
imparting rotation on a fluid by flowing the fluid through a flow duct, the flow duct having a longitudinal axis, and the flow duct comprising:
an outer wall extending along the longitudinal axis and defining an inlet and an outlet, wherein a flow direction is from the inlet to the outlet;
an inner wall comprising an outer surface, an inlet side of the outer surface, which intersects the longitudinal axis and expands radially outward from the longitudinal axis as the outer surface extends in the flow direction, and an outlet side of the outer surface, which contracts radially inward to intersect with the longitudinal axis as the outer surface extends in the flow direction, wherein the outer surface does not have any entrances or passages that allow fluid to flow radially inward of the outer surface;
vanes extending radially outward from the outer surface to the outer wall and extending along and spiraling around the longitudinal axis; and
wherein the outer wall, the inner wall, and the vanes collectively define flow chambers that extend along and spiral about the longitudinal axis.

19. The method of claim 18, further comprising maintaining rotation of the fluid as the fluid flows through a bend or an intersection.

20. The method of claim 19, wherein the flow duct reduces a pressure loss of the fluid flowing through the bend or the intersection.
